(19) United States
(12) Patent Application Publication
(10) Pub. No.: US 2004/0018051 A1
(43) Pub. Date: Jan. 29, 2004

(54) Form board clip for pool cover system

(76) Inventor: David B. Dalton, Heber City, UT (US)

Correspondence Address: KARL R CANNON, PO BOX 1909, SANDY, UT, 84091, US

(21) Appl. No.: 10/307,205

(22) Filed: Nov. 29, 2002

Related U.S. Application Data
(60) Provisional application No. 60/334,290, filed on Nov. 29, 2001.

(51) Int. Cl. F16B 2/14

(52) U.S. Cl. 403/374.2

(57) ABSTRACT

A device for attaching a form board to an edge of a pool to facilitate placement of a concrete deck. The device may include a clip configured to pass through the form board and to attach to a channel formed in a track retainer positioned on an edge of the pool. The clip may include a bolt having a tapered adjustment piece attached to one end and a threaded nut on the opposite end. The nut may be rotated to draw the tapered adjustment piece into an expansion member causing the expansion member to expand. The expansion member may contact a ridge in the channel to from an interference fit to prevent the clip from being removed from the channel. The clip can be quickly fastened and released by simply rotating the nut, thus the clip can be reused repeatedly.

### CROSS-REFERENCE TO RELATED APPLICATIONS

This application claims the benefit of U.S. Provisional Application No. 60/334,290, filed Nov. 29, 2001, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally to attaching devices, and more particularly, but not necessarily entirely, to devices for attaching a form board to a retainer on an edge of a pool to facilitate placement of a concrete deck.

2. Description of Related Art

It is common practice to provide swimming pool cover systems in both residential and commercial swimming pools. Automatic swimming pool cover systems have become quite popular over conventional manually movable covers since they are easy to operate. Swimming pool covers are effective in precluding the collection of debris and leaves in the swimming pool. This helps reduce the frequency and amount of pool maintenance which would otherwise be required. In addition, automatic swimming pool cover systems provide a significant safety factor in that the pool cover can support the weight of a person while it is extended over the water, to prevent drowning while the pool is unattended. Furthermore, swimming pool covers are beneficial in that they reduce heat loss and can actually increase water temperature through solar heating.

The swimming pool cover systems usually include a powered reel upon which a flexible swimming pool cover is rolled. A pair of tracks are typically mounted on opposite sides of the swimming pool and the leading edge of the cover is connected to a motor driven cable arrangement. The swimming pool cover is supported on the pair of tracks to enable the cover to be drawn across the pool when the pool is not in use, and rolled back up on the reel to uncover the pool.

A drawback of the swimming pool cover systems has been that the tracks can interfere with the construction and use of the deck surrounding the pool. The tracks are commonly located in the sidewall of the pool so as to maintain the deck clear for use without tripping the users. However, placement of the tracks on the pool sidewall makes finishing the deck more difficult. Some of the higher end decks and coping are constructed of poured concrete. Placing the pool cover tracks in the sidewalls of the pool has previously made installing forming boards more difficult. This has added to the difficulty and cost in obtaining a poured concrete deck and coping.

One approach to resolve the difficulty in finishing the deck and coping has been to install plastic or metal coping. However, plastic or metal coping may not provide the higher end pool look desired.

Another drawback of the prior art devices is that the devices used to attach the form boards are often designed for a single use and are destroyed when the form boards are removed. This adds to the cost and waste generation of installing form boards.

In view of the drawbacks inherent in the available art, it would be a significant advance in the art to provide a device for attaching a form board to an edge of a pool which is simple in design and manufacture, and which is easy to install, even in applications where pool cover retainers are to be installed in the pool sidewall. It would be a further advancement in the art to provide a form board attachment device which can be reused repeatedly. It would also be an advancement in the art to provide a form board attachment device which facilitates the placement of a concrete deck such that the deck has a high quality appearance, and the need for metal or plastic coping around a swimming pool is eliminated.

The prior art is thus characterized by several disadvantages that are addressed by the present invention. The present invention minimizes, and in some aspects eliminates, the above-mentioned failures, and other problems, by utilizing the methods and structural features described herein.

The features and advantages of the invention will be set forth in the description which follows, and in part will be apparent from the description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the invention will become apparent from a consideration of the subsequent detailed description presented in connection with the accompanying drawings in which:

FIG. 1 is a perspective view of a swimming pool and deck having a track retainer formed in the swimming pool sidewall;

FIG. 2 is a side, cross-sectional view of one embodiment of a device for attaching a form board to an edge of a pool to facilitate placement of a concrete deck, in accordance with the principles of the present invention;

FIG. 3 is a perspective view of a form board clip in accordance with the principles of the present invention;

FIG. 4 is a side, cross-sectional view of an alternative embodiment of a device for attaching a form board to an edge of a pool, in accordance with the principles of the present invention;

FIG. 5 is a side view of a further alternative embodiment of a track retainer.

### DETAILED DESCRIPTION OF THE INVENTION

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

It must be noted that, as used in this specification and the appended claims, the singular forms “a,” “an,” and “the” include plural referents unless the context clearly dictates otherwise.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps.

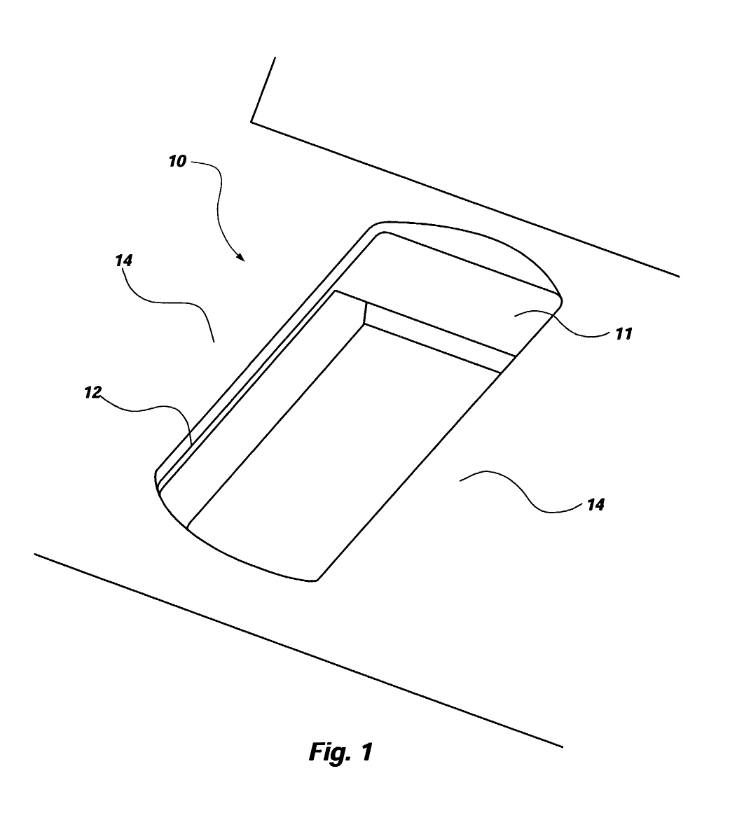

Referring now to FIG. 1, there is shown a recessed swimming pool, designated generally at 10. The pool 10 may be equipped with a pool cover 11 which slides in a track retainer 12 extending lengthwise along each long-side of the pool 10. The pool cover 11 may be of any variety known in the art for covering a pool when the pool 10 is not in use, to prevent debris from entering the pool 10, and further to provide protection against unwanted entry or drowning in the pool 10 while the pool 10 is unattended. The track retainer 12 may form a rectangular recess disposed within the side walls of the pool 10 so that the deck 14 may be maintained unobstructed by the track retainer 12. The deck 14 is the surface area surrounding the pool 10, and may be constructed by placing concrete in forms to establish the desired shape and configuration. The track retainer 12 may be partially encapsulated in the concrete deck 14 to securely hold the track retainer 12 in place and partially obscure the track retainer 12 from view.

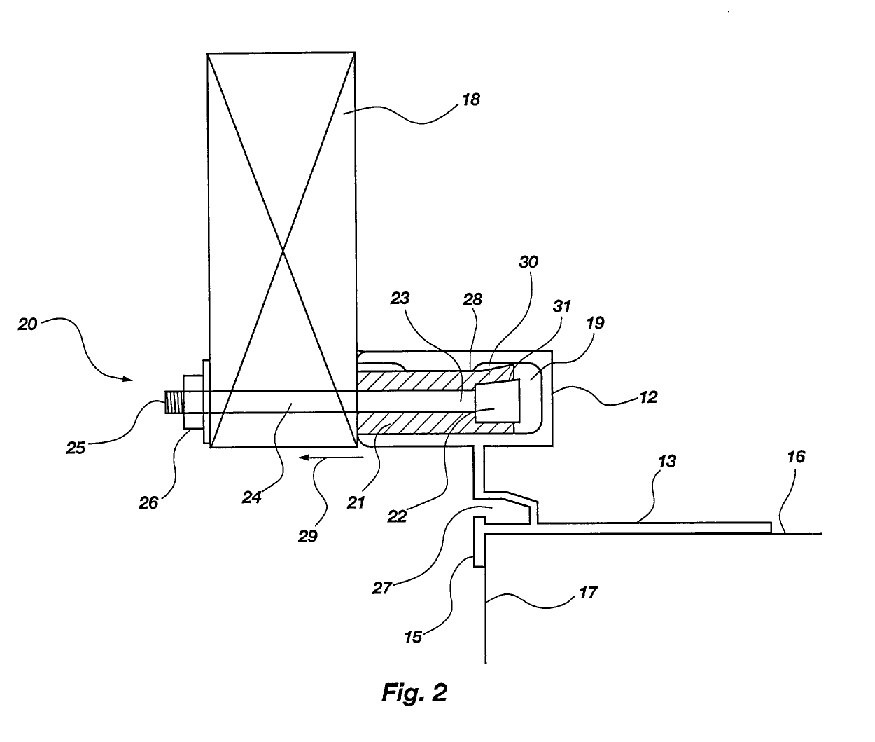

FIG. 2 shows a side, cross-sectional view of one embodiment of a device for attaching a form board 18 to an edge of the pool 10 to facilitate placement of a concrete deck 14, in accordance with the principles of the present invention. Form boards or members 18 are typically made of wood and are assembled in an arrangement to define the perimeter of a concrete pour. The form boards 18 must have adequate strength to support the pressure exerted by wet concrete as the concrete is poured in place so that the concrete will be maintained in its desired configuration. It will be appreciated by those skilled in the art that form boards of various types and dimensions may be used within the scope of the present invention.

Placing the form boards 18 on the edge of a pool 10 has heretofore been difficult to accomplish while maintaining a space for locating the track retainer 12. In the present invention, a track retainer 12 may include a horizontal portion 13 that may be placed on the ground surface, or the top surface of the pool sidewall 16. The track retainer 12 also may include a vertical portion 15 that abuts against a side portion of the pool wall 17. Additionally, the track retainer may include a rectangular space forming a cavity or channel 19 which serves to retain and guide the pool cover 11. The track retainer 12 may also include a liner retainer 27 for receiving liners, such as vinyl liners, in a manner known in the art.

The form board 18 may be attached to the track retainer 12 by a clip member, indicated generally at 20. The clip 20 may include an elongate member or bolt 24 which may extend through an opening in the form board 18. The bolt 24 may have a first end 23 and a second end 25. The first end 23 of the bolt 24 may include an adjustment piece 22 attached thereto. The second end 25 of the bolt 24 may be threaded and may include a rotation member such as a threaded nut 26. An expansion/contraction member 21 may be located on the bolt 24 to reside generally between the form board 18 and the adjustment piece 22. The expansion/contraction member 21 may be constructed of a flexible resilient material having an opening defined by opposing sidewalls 30, configured to receive the adjustment piece 22.

The form board 18 may be attached to the track retainer 12 by attaching the bolt 24 to the form board 18 and inserting the first end of the bolt 24, including the adjustment piece 22 and the expansion/contraction member 21 into the channel 19 of the track retainer 12. In order for the clip 20 to fit into the channel 19 easily, the expansion/contraction member 21 may be in a contracted or relaxed condition. Therefore, the adjustment piece 22 may be positioned far enough outside of the expansion/contraction member 21 so as to allow the walls 30 to remain in a relaxed or contracted state. After the clip 20 has been inserted into the channel 19, the clip 20 can be attached to the track retainer 12 by tightening the threaded nut 26 to draw the adjustment piece 22 in a direction indicated by arrow 29, into the expansion/contraction member 21 between the sidewalls 30. The adjustment piece 22 may be configured to wedge between the sidewalls 30 of the expansion/contraction member 21 to force the sidewalls 30 to deflect outwardly and thus cause the expansion/contraction member 21 to expand. The expansion/contraction member 21 may then form an interference fit with a ridge 28 formed in the channel 19 of the track retainer 12 to prevent the clip 20 from being withdrawn from the channel 19 and thereby attach the form board 18 to the track retainer 12. “Interference fit” as referred to herein means that the ridge 28 blocks movement of the expansion/contraction member 21 by contact, such that the ridge 28 prevents the expansion/contraction member 21 from passing through the ridge 28. An interference fit is therefore distinguished from a friction fit in which two objects are connected by friction alone, without blocking contact. Concrete may then be poured on the track retainer 12 within the form boards 18 to construct the deck 14 while maintaining the channel 19 clear for receiving the pool cover 11.

When the concrete has set and it is desired to remove the form board 18 from the track retainer 12, the threaded nut 26 may simply be loosened and the adjustment piece 22 may be forced out of the expansion/contraction member 21. This allows the expansion/contraction member to again resume a relaxed or contracted condition so the clip 20 can be withdrawn from the channel 19. Since the clip 20 is not destroyed during use, the clip 20 may be reused repeatedly. This saves time assembling the form boards 18 and reduces the cost and waste associated with disposable clips.

It will be appreciated that the expansion/contraction member 21 may have various configurations within the scope of the present invention. For example, the expansion/contraction member 21 may have a tubular shape which expands in diameter upon application of pressure by the adjustment piece 22. Similarly, any other shape or configuration which is adapted to expand when pressure is applied by the adjustment piece 22 is considered to be within the scope of the present invention. Likewise the adjustment piece 22 may have various configurations corresponding to the expansion/contraction member 21. For example, the adjustment piece 22 may have a polygonal cross section, or a conical shape along the axis of the bolt 24. Furthermore, the adjustment piece 22 may have a tapered surface 31 to assist in causing the expansion/contraction member 21 to expand.

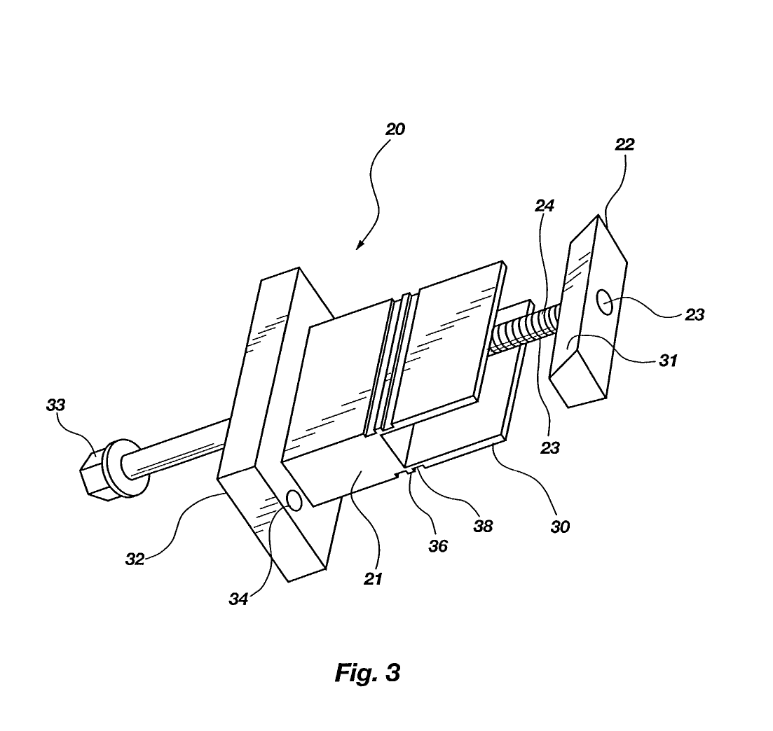

A perspective view of one embodiment of a form board clip 20, in accordance with the principles of the present invention, is shown in FIG. 3. As shown in the embodiment of FIG. 3, the clip 20 may include an attachment base 32 for attaching the expansion/contraction member 21 to the form board 18. The attachment base 32 may receive fasteners 34 such as nails or screws to attach the clip 20 to the form board 18. A plurality of clips 20 may be attached to the form board 18 at a desired spacing, such as two (2) feet apart for example, to provide adequate strength to maintain the form board 18 in position.

The expansion/contraction member 21 also may include one or more ribs 36 to improve the interference fit with the track retainer 12. The ribs 36 may be formed in a side of the expansion/contraction member 21 by a series of recesses 38. The recesses 38 may provide a reduced cross-sectional area which allows the sidewalls 30 to expand and contract more easily. When the expansion/contraction member 21 expands, the ribs 36 may also grip the track retainer 12 to firmly attach the form board 18 to the track retainer 12.

It will be appreciated by those skilled in the art that rather than having the threads on the second end 25 of the bolt 24, and turning the threaded nut 26 to draw in the adjustment piece 22, the first end 23 of the bolt 24 may be threaded to the adjustment piece 22. In this configuration, the bolt 24 may have a head 33 that serves as a rotation member to be turned to draw the adjustment piece 22 into the expansion/contraction member 21.

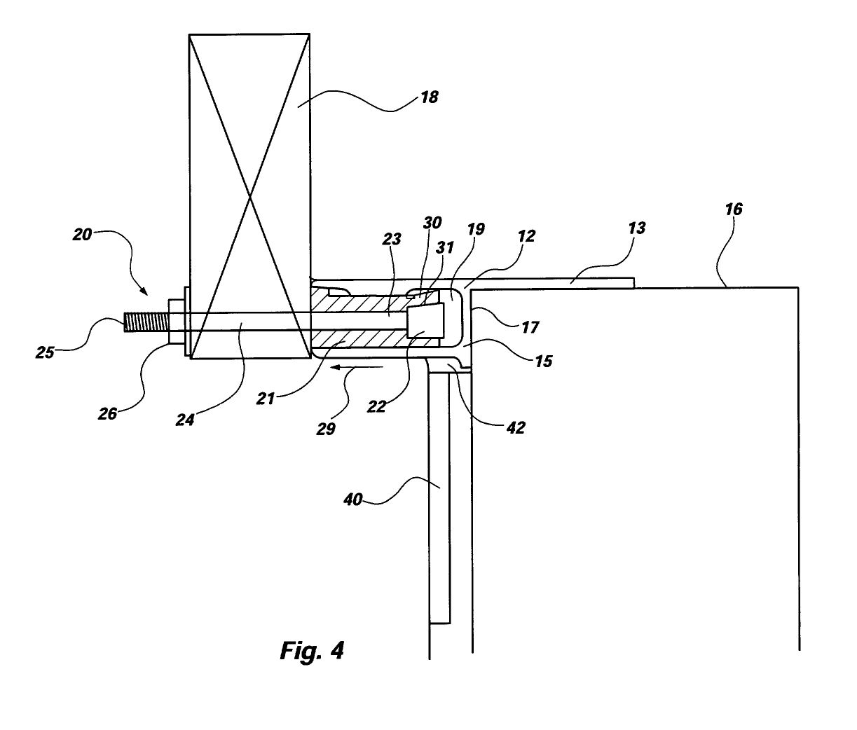

Reference will now to made to FIG. 4 to describe a second embodiment of the track retainer 12 of the present invention. As previously discussed, the presently described embodiments of the invention illustrated herein are merely exemplary of the possible embodiments of the invention, including that illustrated in FIG. 4.

It will be appreciated that the second embodiment of the invention illustrated in FIG. 4 contains many of the same structures represented in FIGS. 1-3 and only the new or different structures will be explained to most succinctly explain the additional advantages which come with the embodiments of the invention illustrated in FIG. 4. The second embodiment of the track retainer 12 is configured to be attached to a pool 10 having a sidewall made of gunite for example, and tile 40 on the pool sidewall, rather than a vinyl liner system such as the system made possible by the embodiment of FIG. 2. The appearance and durability of the interface between the track retainer 12 and tile 40 may be improved by installing a flexible grout 42 between the track retainer 12 and the tile 40. This configuration eliminates the need for a liner retainer 27 so that the horizontal portion 13 of the track retainer 12 may be located on the top of the track retainer 12.

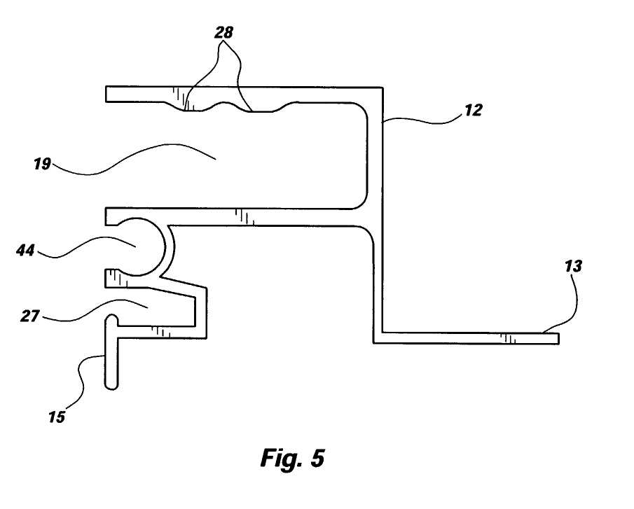

Reference will now to made to FIG. 5 to describe a third embodiment of the track retainer 12 of the present invention. It will be appreciated that the third embodiment of the invention illustrated in FIG. 5 contains many of the same structures represented in FIGS. 1-4 and only the new or different structures will be explained to most succinctly explain the additional advantages which come with the embodiments of the invention illustrated in FIG. 5. The third embodiment of the track retainer 12 illustrates that the track retainer 12 may have various different configurations within the scope of the present invention. The third embodiment of the track retainer 12 may include an additional ridge 28 to assist in forming an interference fit with the clip 20. It will be appreciated that the track retainer 12 may include any number of ridges 28 within the scope of the present invention. The embodiment of the track retainer 12 shown in FIG. 5 also may include an auxiliary channel 44 for housing other components of the swimming pool 10, such as cables or fiber optic lighting for example. The shape, size, and location of the auxiliary channel 44 may be modified within the scope of the present invention to be compatible with its intended use.

In accordance with the features and combinations described above, a useful method of installing a form board for facilitating placement of concrete includes the steps of:

(a) attaching a clip to the form board;

(b) positioning a retainer in a location where the form board is to be installed, the retainer having a cavity;

(c) inserting the clip into the cavity and expanding the clip to attach the clip to the retainer; and

(d) contracting the clip to allow the clip to be removed from the cavity without damaging the clip.

In view of the foregoing, it will be appreciated that the present invention provides a device for attaching a form board to an edge of a pool which is simple in design and manufacture, which can be reused repeatedly, and which is easy to install, even in applications where pool cover retainers are to be installed in the pool sidewall. The present invention also provides a form board attachment device which facilitates the placement of a concrete deck such that the deck has a high quality appearance, and the need for metal or plastic coping around the swimming pool is eliminated.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A device for attaching a member to a retainer, said device comprising:
an adjustment piece having a tapered surface; and
an expansion member having an opening defined by opposing sidewalls, said expansion member configured to fit inside said retainer;
wherein said tapered surface of said adjustment piece is configured to enter said opening in said expansion member to force said opposing sidewalls to deflect to attach said device to said retainer.

2. The device of claim 1, further comprising an elongate member having a first end and a second end.

3. The device of claim 2, wherein said elongate member comprises a bolt, and wherein said second end is threaded.

4. The device of claim 3, further comprising a threaded nut attached to said second end of said bolt.

5. The device of claim 4, wherein said adjustment piece is attached to said first end of said elongate member.

6. The device of claim 5, wherein said adjustment piece has a polygonal cross section.

7. The device of claim 1, wherein said sidewalls comprise at least one rib to form an interference fit with said retainer.

8. The device of claim 1, wherein the expansion member further comprises an attachment base for attaching the expansion member to the form board.

9. The device of claim 8, wherein said attachment base further comprises fasteners for attaching the expansion member to the form board.

10. A device for attaching a form board to a retainer on an edge of a pool to facilitate placement of a concrete deck, said device comprising:
an elongate member for attaching to said form board, said elongate member having a first end and a second end;
an adjustment piece disposed on said first end of said elongate member;
a rotation member disposed on said second end of said elongate member; and
an expansion member disposed on said elongate member;
wherein said device is configured such that when said device is attached to a form board, rotation of said rotation member draws said adjustment piece inside said expansion member to cause said expansion member to expand to attach said device to said retainer.

11. The device of claim 10, wherein said elongate member comprises a bolt, and wherein said second end of said elongate member is threaded.

12. The device of claim 10, wherein said rotation member comprises a threaded nut.

13. The device of claim 10, wherein said adjustment piece has a polygonal cross section.

14. The device of claim 10, wherein said expansion member comprises a pair of opposing sidewalls.

15. The device of claim 14, wherein said sidewalls comprise at least one rib to form an interference fit with said retainer.

16. The device of claim 10, wherein the expansion member further comprises an attachment base for attaching the expansion member to the form board.

17. The device of claim 16, wherein said attachment base further comprises fasteners for attaching the expansion member to the form board.

18. A device for attaching a form board to a retainer on an edge of a pool to facilitate placement of a concrete deck, said device comprising:
an elongate member for attaching to said form board, said elongate member having a first end and a second end;
an adjustment piece disposed on said first end of said elongate member; and
an expansion member disposed on said elongate member, said expansion member having an opening defined by opposing sidewalls;
wherein said elongate member is configured to move said adjustment piece into said opening to cause said opposing sidewalls to deflect away from said adjustment piece to attach said device to said retainer, and said elongate member is configured to move said adjustment piece away from said expansion member to allow said device to be released from said retainer.

19. The device of claim 18, wherein said elongate member comprises a bolt, and wherein said second end is threaded.

20. The device of claim 19, further comprising a threaded nut attached to said second end of said bolt.

21. The device of claim 18, wherein said adjustment piece has a polygonal cross section.

22. The device of claim 18, wherein said sidewalls comprise at least one rib to form an interference fit with said retainer.

23. The device of claim 18, wherein the expansion member further comprises an attachment base for attaching the expansion member to the form board.

24. The device of claim 23, wherein said attachment base further comprises fasteners for attaching the expansion member to the form board.

25. An assembly for attaching a form board to an edge of a pool to facilitate placement of a concrete deck, said assembly comprising:
a retainer for positioning on said edge of said pool, said retainer having a channel; and
a clip member, said clip member having an expansion portion that adjusts between a first relaxed condition in which said expansion portion is allowed to slide in and out of said channel, and a second expanded condition in which said expansion portion is fixed in said channel to prevent said expansion portion from being removed from said channel,
wherein said clip member is configured to attach said form board to said retainer.

26. The assembly of claim 25, wherein said clip member further comprises an elongate member having a first end and a second end.

27. The assembly of claim 26, wherein said elongate member comprises a bolt, and wherein said second end is threaded.

28. The assembly of claim 27, further comprising a threaded nut attached to said second end of said bolt.

29. The assembly of claim 26, wherein said clip member further comprises an adjustment piece attached to said first end of said elongate member.

30. The assembly of claim 29, wherein said adjustment piece has a tapered shape.

31. The assembly of claim 25, wherein said expansion portion further comprises a pair of opposing sidewalls.

32. The assembly of claim 31, wherein said sidewalls comprise at least one rib, said at least one rib forming an interference fit with said retainer when said expansion portion is in said second expanded condition.

33. The assembly of claim 25, wherein the expansion portion further comprises an attachment base for attaching the expansion portion to the form board.

34. The assembly of claim 33, wherein said attachment base further comprises fasteners for attaching the expansion portion to the form board.

35. The assembly of claim 25, wherein said channel comprises at least one ridge to provide an interference fit with said expansion portion when said expansion portion is in said second, expanded condition.

36. An assembly for attaching a form board to an edge of a pool to facilitate placement of a concrete deck, said assembly comprising:
a retainer for positioning on said edge of said pool, said retainer having a channel; and
a clip member for attaching said form board to said retainer, said clip member having an expansion portion and an adjustment piece;
wherein said adjustment piece is configured to move with respect to said expansion portion to force said expansion portion to releasably engage with said channel to thereby attach said form board to said retainer.

37. The assembly of claim 36, wherein said clip member further comprises an elongate member having a first end and a second end.

38. The assembly of claim 37, wherein said elongate member comprises a bolt, and wherein said second end is threaded.

39. The assembly of claim 38, further comprising a threaded nut attached to said second end of said bolt.

40. The assembly of claim 37, wherein said adjustment piece is attached to said first end of said elongate member.

41. The assembly of claim 36, wherein said adjustment piece has a tapered shape.

42. The assembly of claim 36, wherein said expansion portion further comprises a pair of opposing sidewalls.

43. The assembly of claim 42, wherein said sidewalls comprise at least one rib, said at least one rib forming an interference fit with said channel when said expansion portion is attached to said retainer.

44. The assembly of claim 36, wherein the expansion portion further comprises an attachment base for attaching the expansion portion to the form board.

45. The assembly of claim 44, wherein said attachment base further comprises fasteners for attaching the expansion portion to the form board.

46. The assembly of claim 36, wherein said channel comprises at least one ridge to provide an interference fit with said expansion portion.

47. An assembly for attaching a form board to an edge of a pool to facilitate placement of a concrete deck, said assembly comprising:
a retainer for positioning on said edge of said pool, said retainer having a channel;
an elongate member, said elongate member having a length; and
an expansion portion attached to said elongate member;
wherein said elongate member is movable with respect to said expansion portion in a direction along said length, wherein said expansion portion is configured to move in and out of said channel when said expansion portion is located at a first position along said length, and said expansion portion is configured to attach to said channel when said expansion portion is located at a second position along said length so as to attach said form board to said retainer.

48. The assembly of claim 47, wherein said elongate member comprises a bolt having a threaded end.

49. The assembly of claim 48, further comprising a threaded nut attached to said threaded end of said bolt.

50. The assembly of claim 47, further comprising an adjustment piece attached to said elongate member.

51. The assembly of claim 50, wherein said adjustment piece has a tapered shape.

52. The assembly of claim 47, wherein said expansion portion further comprises a pair of opposing sidewalls.

53. The assembly of claim 52, wherein said sidewalls comprise at least one rib, said at least one rib forming an interference fit with said channel when said expansion portion is attached to said retainer.

54. The assembly of claim 47, wherein the expansion portion further comprises an attachment base for attaching the expansion portion to the form board.

55. The assembly of claim 54, wherein said attachment base further comprises fasteners for attaching the expansion portion to the form board.

56. The assembly of claim 47, wherein said channel comprises at least one ridge to provide an interference fit with said expansion portion.

57. A method of installing a form board for facilitating placement of concrete, said method comprising the steps of:
(a) attaching a clip to said form board;
(b) positioning a retainer in a location where the form board is to be installed, said retainer having a cavity;
(c) inserting the clip into the cavity and expanding the clip to attach the clip to the retainer; and
(d) contracting the clip to allow the clip to be removed from the cavity without damaging the clip.

58. The method of claim 57, wherein step (a) further comprises inserting fasteners through an attachment base of said clip and into said form board.

59. The method of claim 57, wherein step (c) further comprises forcing an adjustment piece into an expansion member using an elongate member to cause said expansion member to expand.

60. The method of claim 59, wherein step (c) further comprises forming an interference fit between said expansion member and said retainer.

61. The method of claim 59, wherein step (c) further comprises rotating a threaded nut on said elongate member to draw said adjustment piece into said expansion member.

62. The method of claim 59, wherein step (c) further comprises rotating said elongate member to move said adjustment piece with respect to said expansion member.

63. The method of claim 59, wherein step (d) further comprises moving said adjustment piece away from said expansion member.

64. The method of claim 59, wherein step (d) further comprises rotating a threaded nut to allow said adjustment piece to move away from said expansion member.

65. The method of claim 57, further comprising (e) pulling the clip out of the cavity.

66. A method for attaching a form board to a retainer for facilitating placement of concrete, said method comprising the steps of:
(a) attaching a clip to said form board, said clip comprising an expansion portion and an adjustment piece;
(b) inserting said expansion portion into an opening in said retainer; and
(c) moving said adjustment piece into said expansion portion to cause said expansion portion to expand and thereby fix said clip to said retainer.

67. The method of claim 66, wherein step (c) further comprises pulling said adjustment piece into said expansion portion with an elongate member.

68. The method of claim 67, wherein step (c) further comprises rotating a threaded nut on said elongate member to move said elongate member and said adjustment piece with respect to said expansion portion.

69. The method of claim 67, wherein step (c) further comprises rotating said elongate member to move said adjustment piece with respect to said expansion portion.

70. The method of claim 66, wherein step (c) further comprises forcing said adjustment piece against opposing side walls of said expansion portion to cause said opposing side walls to deflect away from said adjustment piece.

71. The method of claim 66, wherein step (c) further comprises forming an interference fit between said expansion portion and said retainer.

72. The method of claim 66, wherein step (a) further comprises inserting fasteners through an attachment base of said clip and into said form board.

73. The method of claim 66, further comprising step (d) removing said form board from said retainer such that said clip can be reused.

74. The method of claim 73, wherein step (d) further comprises constricting said expansion portion.

75. The method of claim 73, wherein step (d) further comprises moving said adjustment piece away from said expansion portion.

76. The method of claim 75, wherein step (d) further comprises rotating a threaded nut on an elongate member to move said adjustment piece with respect to said expansion portion.

77. A device for attaching a form board to a retainer on an edge of a pool to facilitate placement of a concrete deck, said device comprising:
an elongate member for attaching to said form board, said elongate member having a first end and a second end;
an adjustment piece disposed on said first end of said elongate member;
a rotation member disposed on said second end of said elongate member; and
an expansion member disposed on said elongate member between said rotation member and said adjustment piece;
wherein said elongate member comprises a bolt, and wherein said second end of said elongate member is threaded;
wherein said rotation member comprises a threaded nut;
wherein said adjustment piece has a polygonal cross section forming a tapered surface;
wherein said expansion member comprises an opening defined by a pair of opposing sidewalls;
wherein said sidewalls comprise at least one rib to form an interference fit with said retainer;
wherein the expansion member further comprises an attachment base for attaching the expansion member to the form board;
wherein said attachment base further comprises fasteners for attaching the expansion member to the form board;
wherein said device is configured such that when said device is attached to a form board, rotation of said rotation member draws said adjustment piece inside said opening in said expansion member to cause said opposing sidewalls to deflect away from said adjustment piece to attach said device to said retainer.
